(19) United States
(12) Patent Application Publication
(10) Pub. No.: US 2006/0168622 A1
(43) Pub. Date: Jul. 27, 2006

(54) Real-time synchronization of content viewers

(75) Inventors: Leonard H.D. Poll, REDHILL (GB); Stefaan M.M. Note, Berchem (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/547,451

(22) PCT Filed: Feb. 19, 2004
(86) PCT No.: PCT/IB04/00519

§ 371 Date: Aug. 29, 2005

(30) Foreign Application Priority Data
Mar. 1, 2003 (GB) 0304763.6

(51) Int. Cl. H04H 9/00; H04N 5/445; H04N 7/10; G06F 3/00; G06F 13/00; H04N 7/025; H04N 7/16

(52) U.S. Cl. 725/46; 725/34; 725/35; 725/9

(57) ABSTRACT

A method and apparatus for improving user access to content of interest to the user across a range of media and formats is provided, the method comprising a) identifying the content of a user selected content source conveyed to a user by a user's content conveyer apparatus, b) searching all available content sources and/or previously provided descriptions of content sources for content similar to that identified in step a), c) identifying content sources searched in step b) which contain similar content, and d) configuring content conveyers, on start up, to display a content source identified in step c).

This invention relates to a method and apparatus enabling viewers interested in a particular topic to view content covering that topic, sequentially or simultaneously in a multiplicity of different media and formats (e.g. audio/video/html). The method and apparatus are embodied in a system having a user interface which system responds to a user's request to access a selected content source by providing quick access to other content sources containing similar content in different formats.

It is now possible through a single display apparatus to view and/or listen to material embodied in a wide variety of media formats. For example, a user may, through a suitably configured TV receiving apparatus, view TV broadcasts, web sites, teletext data or pre-recorded video data and listen to radio broadcasts or pre-recorded music data. Content within each format may be varied and across these formats, there may exist similar or related content.

It is known from US2002/0129367 to provide a system whereby a user can actively select related content from a multiplicity of media formats which can be conveyed to a user via a content conveyer apparatus (such as a TV screen) of the system. The user can have these content sources recorded and replayed in a user specified order starting at a user specified time. For example, a user interested in international news may search from a range of television broadcasts and a range of radio broadcasts, select the programmes of most interest to him and prepare an ordered play list of these programmes to be played back at the specified time. However, in order to find the relevant content, the user must first actively search through available sources of the content in each medium and each available format for each medium and select his preferred content sources for recordal and playback.

The inventors are not aware of any existing context or content aware systems which can remove or relieve the burden of searching across a multitude of media and media formats in order to find a wide range of information on a common theme. The present invention aims to provide such a content and/or context aware system.

According to a first aspect of the invention there is provided a method for improving user access to content of interest to the user across a range of media and formats, the method comprising:

a) identifying the content of a user selected content source conveyed to a user by a user's content conveyer apparatus,

b) searching all available content sources for content similar to that identified in step a), and

c) identifying content sources searched in step b) which contain similar content.

Available content sources to be searched in step b) might include any or all of; websites, television broadcasts (optionally listed in an EPG), radio broadcasts, teletext pages and pre-recorded files video or audio files accessible by a single content conveyer apparatus or individually through one or more content conveyer apparatus in a network. In this context, the term “content conveyer apparatus” is intended to include any means for communicating content to a user, for example a visual display apparatus or an audio output apparatus.

Various methods may be employed to determine the content in step a). For example, where the content of the user selected content source is provided in written form, previously tagged key words may be used as a basis on which to implement the search. Similarly TV or radio broadcasts may be already listed in an electronic programme guide (EPG) and keywords in the listed program details may be used as parameters for the search. Rather than using previously tagged key words, the system may use regularly repeated words or phrases to determine content. Where files have been pre-recorded by a user, these too may have been catalogued in a user's home entertainment system in a manner similar to an EPG, again key words from the catalogued data can be used as search parameters. In more sophisticated arrangements images or sounds may be identified and translated into parameters for a search.

In an alternative approach, a historic record may be kept of content sources retrieved by a viewer in close succession. For example, where a user has switched frequently between a given, regularly aired TV broadcast and a given website, that TV and website will be assumed to include similar content, thus when the said TV broadcast is selected for viewing by the user, the search will be for content sources in other media/formats which, according to the historic records have frequently been accessed during or shortly before or after the TV broadcast.

In such an example, the TV broadcast may be a weekly broadcast of horse race meetings, the user may have a history of, during that weekly broadcast, checking the web site of a local turf accountant for prices on horses running in the race. Also, the user may prefer the race commentary of a radio broadcaster to that of the TV broadcaster and may periodically switch to the audio output of the radio broadcast whilst still viewing the TV broadcast. From historic records, it can be determined that the content of the turf accountant's web site and the race commentary radio broadcast is “similar” to that of the TV broadcast.

Optionally, recorded history and relevant parameter searching may both be utilised to identify the content sources in step c). Content sources identified as most relevant in a relevant parameter search are compared against content sources identified as relevant based on a recorded history. If the highest ranking content source of a given format found in the relevant parameter search matches the highest ranking content source in the same format based on the historic record, then the historic content source is identified as the appropriate content source to be conveyed when content in that format is requested by the user. If the content sources differ, then the highest ranking content source from the recorded history is checked for relevance against the search parameters used in the relevant parameter search. If the highest ranking recorded history source is found to be equally or more relevant than the highest-ranking source found in the relevant parameter search, then the recorded history source is identified as the appropriate content source for that format. If the result of the relevant parameter search is found to have more relevant content than the recorded history source then the content source found in the relevant parameter search is identified as the appropriate content source for that format. Optionally, the user may be presented with a choice of these two content sources from which he can select his preferred content source.

Once the similar content sources are identified, a variety of options exist for providing these to the user. In a first option, the identified files may simply be provided in an ordered list for display to the user via a display device. In such an option, the user may select content sources from the list and be directly linked to the selected content source. The selected content source may be conveyed in place of the current content source or may be conveyed in a separate conveyer. For example, if both sources are visual, the display on a visual display apparatus may be presented as a split screen or as a window within a window and both the current and selected content source conveyed simultaneously to the viewer. In an alternative example, say when the current content is visual and the selected content is audio, the current content is continuously conveyed via the visual display apparatus and the selected content conveyed via a separate audio output device.

In a second option, once the similar content sources are identified, a or each content conveyer apparatus for conveying each format of content source is instructed to convey the identified content source on start up of the content conveyer apparatus. Thus, if a user is viewing a TV broadcast and switches to the internet, he is automatically presented with a website including similar content to the TV broadcast. In this option, the user need not be interrupted with results of the search but has the convenience that, should he wish to switch to an alternate medium for another perspective on content he is currently receiving, he may quickly locate the relevant content source in the alternate medium. Returning to the previous example, when the horse race meeting TV broadcast is selected by the user for viewing, the radio commentary broadcast and turf accountants web site will be identified in step c) of the method. Using a system configured to perform the method, should the user tune to the weekly, televised, horse race meeting and then consult his web browser, the web browser will automatically present the turf accountant's website on start up, irrespective of any default settings for the web browser. Similarly, should the user access his audio system, that system will automatically tune to the station broadcasting the preferred radio commentary, again irrespective of what radio station was previously selected or any default settings.

The method is conveniently carried out by a processor forming part of a management system within a content conveyer apparatus or as part of a network comprising a plurality of content conveyer apparatus.

Thus in a second aspect the invention comprises; a content conveyer apparatus configured, on demand, to convey to a user, user selected content in a plurality of formats, and a management system, the management system configured to perform the aforementioned method(s) of invention.

The content conveyer apparatus may be embodied in a single device or may comprise a plurality of individual content conveyer apparatus each associated with different devices. Where there is a plurality of conveyer apparatus these may be networked, either in a server centred network arrangement or in a distributed network arrangement.

The management system may be embodied in a single device having a single processor configured to perform the method(s) of the invention. Alternatively, the management system may take the form of a plurality of processors each one being located in one of a plurality of conveyer apparatus. This plurality of processors may be configured jointly and/or individually to perform the method(s) of the invention. Optionally, the processor may be embodied in a multi-purpose remote control unit used by the user to interface with one or more content conveyer apparatus. In another option, the processor may be embodied in a television receiving apparatus. In yet another option, the processor may be embodied in a central server which server is in telecommunication with one or more content conveyer apparatus, which content conveyer apparatus may be networked. In the latter option, the server may be local to the network or may be remotely located.

Where a user's system comprises a plurality of content conveyer apparatus, each conveyer apparatus may include a conveyer apparatus processor with which a central processor may communicate. For example, in such an arrangement, the central processor may receive information on a user selected content source being conveyed by any one content conveyer apparatus. The central processor identifies the content of the content source and formulates appropriate search parameters for locating content sources with similar content. The central processor then communicates these search parameters to each conveyer apparatus processor, which in turn perform the search step. When appropriate content sources are identified, they may, optionally, be relayed back to the central processor, or each conveyer apparatus processor may take further method steps locally, for example by configuring the conveyer apparatus to tune to the identified appropriate content source on start up the conveyer apparatus. It is to be understood that in the foregoing embodiment, the “central processor” may in fact be any one of the conveyer apparatus processors operating as a central processor when that conveyer apparatus is first activated by the user, thus the system may operate as a distributed network rather than a server centred network.

Where a historic record of user preferences is maintained, this may be maintained centrally or locally based on the format of content sources conveyable by a content conveyer apparatus.

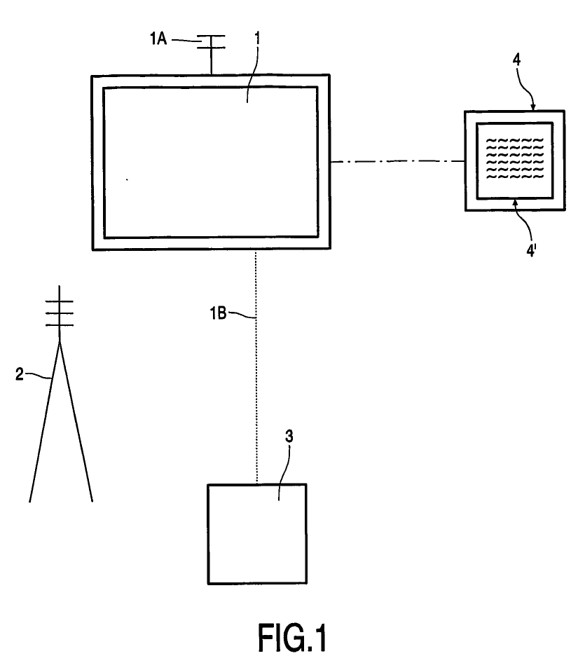

For the purposes of exemplification embodiments of the invention will now be further described with reference to the drawing in which FIG. 1 illustrates schematically one embodiment of an apparatus according to the invention.

FIG. 1 shows a television receiving apparatus 1 configured to receive TV signals from a broadcaster 2 via an aerial 1A. In addition, the television receiving apparatus can receive Internet information such as web sites or Internet radio broadcasts from internet service provider 3 via a telecommunications link 1B. A remote control unit 4 wirelessly linked with a processor (not shown) in the television receiving apparatus 1 is configured to enable the user to interface with the television receiving apparatus 1, for example to change TV channels or to search the internet for a web site. The remote control apparatus includes its own processor (not shown) and its own viewing screen 4′.

An EPG displayable both on the television receiving apparatus screen and screen 4′ of the remote control unit 4 is stored in either or both of the processors. The EPG includes titles of TV or radio broadcasts receivable by the television receiving apparatus 1 and brief descriptions of the content. The EPG may also include embedded tags on key words that describe the content of each broadcast.

A user selects from the EPG a TV station for viewing. When the selection is made, information relating to content is gleaned from the EPG and used by one or both processors to set up search parameters in the form of key words. An Internet search is carried out using these search parameters. Once compiled, a list of the most relevant websites and internet radio broadcasts is displayed to the user on the remote control screen 4′. The selected TV program continues to be received and displayed on the screen of the television receiving apparatus 1. The user may then select an identified relevant internet site from the list provided on the screen 4′ and open a browser, either on the screen 4′ or on the screen of the television receiving apparatus 1. If no selection is made from the list, the list may be removed from display, however, location information on the most relevant web site found in the search will be stored in the processor's memory. Should the user decide at a later time during the TV broadcast to open his web browser, the most relevant website will be displayed on start up.

It will be understood the foregoing is merely exemplary of one embodiment of the invention others of which will no doubt occur to the skilled addressee without departing form the true scope of the invention as defined by the appended claims.

1. A method for improving user access to content of interest to the user across a range of media and formats, the method comprising:
a) identifying the content of a user selected content source conveyed to a user by a user's content conveyer apparatus (1),
b) searching all available content sources and/or previously provided descriptions of content sources for content similar to that identified in step a), and
c) identifying content sources searched in step b) which contain similar content.

2. A method as claimed in claim 1 wherein step a) involves recognising key words or phrases in the content of the user selected content source or in a previously provided description of the user selected content source.

3. A method as claimed in claim 2 wherein step b) involves using the key words or phrases as search parameters for the search in step b)

4. A method as claimed in any preceding claim wherein step b) involves searching a historic record for content sources frequently consulted during conveyance of the user selected content source of step a).

5. A method as claimed in claim 3 or claim 4 wherein step c) involves ranking the search results of a parameter based search for relevance and identifying the most relevant (highest ranking) content source in each available content source format.

6. A method as claimed in claim 4 or 5 wherein step c) involves ranking the frequently consulted content sources in order of most frequently consulted and identifying the highest ranking content source in each available content source format.

7. A method as claimed in claim 6 wherein step c) further involves comparing an identified, frequently consulted content source with an identified content source of the same format in the parameter based search and, if the two sources are not the same, checking the relevance of the identified, frequently consulted source against the search parameters used in the relevant parameter search, and selecting the most relevant content source based on the search parameters.

8. A method as claimed in any preceding claim further comprising, compiling an ordered list of the content sources identified in step c) for display to the user.

9. A method as claimed in any preceding claim further comprising for each available format of content source, configuring the appropriate content conveyer apparatus (1, 4) for that format to convey a content source identified in step c) on start up.

10. An apparatus for improving user access to content of interest to the user across a range of media and formats, the apparatus comprising;
a content conveyer apparatus (1) configured, on demand, to convey to a user, user selected content in a plurality of formats, and
a management system, the management system configured to perform the method of any or all of claims 1 to 9.

11. An apparatus as claimed in claim 10 wherein the content conveyer apparatus (1) is embodied in a single device.

12. An apparatus as claimed in claim 10 wherein the content conveyer apparatus comprises a plurality of individual content conveyer apparatus (1) each associated with different devices.

13. An apparatus as claimed in claim 12 wherein the plurality of content conveyer apparatus (1, 4) is networked.

14. An apparatus as claimed in claim 13 wherein the network is server centred.

15. An apparatus as claimed in claim 13 wherein the network is distributed.

16. An apparatus as claimed in any preceding claim wherein the management system is embodied in a single device having a single processor configured to perform the method of any of claims 1 to 9.

17. An apparatus as claimed in any of claims 10 to 15 wherein the management system comprises a plurality of processors each processor being located in one of a plurality of content conveyer apparatus.

18. An apparatus as claimed in claim 17 wherein the plurality of processors is configured jointly to perform the method of any of claims 1 to 9.

19. An apparatus as claimed in claim 17 or 18 wherein the plurality of processors is configured individually to perform the method of any of claims 1 to 9.

20. An apparatus as claimed in claim 16 wherein the processor is embodied in a multi-purpose remote control unit usable by the user to interface with one or more content conveyer apparatus.

21. An apparatus as claimed in claim 16 wherein the processor is embodied in a television receiving apparatus.

22. An apparatus as claimed in claim 16 wherein the processor is embodied in a central server which server is in telecommunication with one or more content conveyer apparatus in a network.

23. An apparatus as claimed in claim 22 wherein the server is located remotely from the network.

24. A computer program operable when installed on a computer to cause the computer to perform the method of any of claims 1 to 9.

25. A carrier medium carrying the computer program of claim 24.
